(19) United States
(12) Patent Application Publication
(10) Pub. No.: US 2022/0237041 A1
(43) Pub. Date: Jul. 28, 2022

(54) PARALLEL PROCESSING SYSTEM PERFORMING IN-MEMORY PROCESSING

(71) Applicants: SK hynix Inc., Icheon (KR); Korea University Research and Business Foundation, Seoul (KR)

(72) Inventors: Wonjun LEE, Seoul (KR); Changhyun KIM, Seongnam (KR); Seonwook KIM, Icheon (KR)

(21) Appl. No.: 17/472,082

(22) Filed: Sep. 10, 2021

(30) Foreign Application Priority Data
Jan. 25, 2021 (KR) 10-2021-0010442

(51) Int. Cl. G06F 9/50; G06F 9/38; G06F 9/54

(52) U.S. Cl. CPC G06F 9/5027; G06F 9/5016; G06F 9/541; G06F 9/3877; G06F 9/3836

(57) ABSTRACT

A parallel processing system includes a host and a memory device. The host includes a central processing unit configured to process processing in-memory (PIM) requests generated in a plurality of threads for in-memory processing and a memory controller configured to generate a PIM command corresponding to the PIM request. The memory device including a plurality of computing cores each including a bank and a computing circuit. The memory device is configured to perform in-memory processing in one of the plurality of computing cores according to the PIM command. The host allocates the plurality of computing cores to the plurality of threads, and PIM commands of each thread are processed using the computing core allocated to that thread.

### CROSS-REFERENCE TO RELATED APPLICATION

The present application claims priority under 35 U.S.C. § 119(a) to Korean Patent Application No. 10-2021-0010442, filed on Jan. 25, 2021, which is incorporated herein by reference in its entirety.

### BACKGROUND

### 1. Technical Field

Various embodiments generally relate to a parallel processing system performing in-memory processing.

### 2. Related Art

In relation to parallel computing using shared memory, application programming interfaces (APIs) such as the Open Multi-Processing (OpenMP) API are being developed.

Recently, a technology for performing in-memory processing using a memory device having a built-in computing circuit has been developed.

However, a system for efficiently performing in-memory processing by a host controlling a memory device having a built-in computing circuit and an operating method thereof have not been provided.

Accordingly, there is a problem in that it is difficult to adapt many program codes previously developed in the field of parallel computing, such as OpenMP program codes, to utilize in-memory processing.

### SUMMARY

In accordance with an embodiment of the present disclosure, a parallel processing system may include a host including a central processing unit configured to process a processing in-memory (PIM) request generated in a plurality of threads for in-memory processing and a memory controller configured to generate a PIM command corresponding to the PIM request; and a memory device including a plurality of computing cores each including a bank and a computing circuit, the memory device configured to perform in-memory processing in one of the plurality of computing cores according to the PIM command, wherein the host allocates the plurality of computing cores to the plurality of threads.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and explain various principles and advantages of those embodiments.

FIG. 1 illustrates a parallel processing system according to an embodiment of the present disclosure.

FIG. 2 illustrates a relation between a thread and a computing core according to an embodiment of the present disclosure.

FIG. 3 illustrates indicating a computing core using an address according to an embodiment of the present disclosure.

FIG. 4 illustrates a flow of in-memory processing according to an embodiment of the present disclosure.

FIG. 5 illustrates an example of in-memory processing according to an embodiment of the present disclosure.

FIGS. 6A and 6B illustrate program codes for parallel processing.

### DETAILED DESCRIPTION

The following detailed description references the accompanying figures in describing illustrative embodiments consistent with this disclosure. The embodiments are provided for illustrative purposes and are not exhaustive. Additional embodiments not explicitly illustrated or described are possible. Further, modifications can be made to presented embodiments within the scope of teachings of the present disclosure. The detailed description is not meant to limit this disclosure. Rather, the scope of the present disclosure is defined in accordance with claims and equivalents thereof. Also, throughout the specification, reference to “an embodiment” or the like is not necessarily to only one embodiment, and different references to any such phrase are not necessarily to the same embodiment(s).

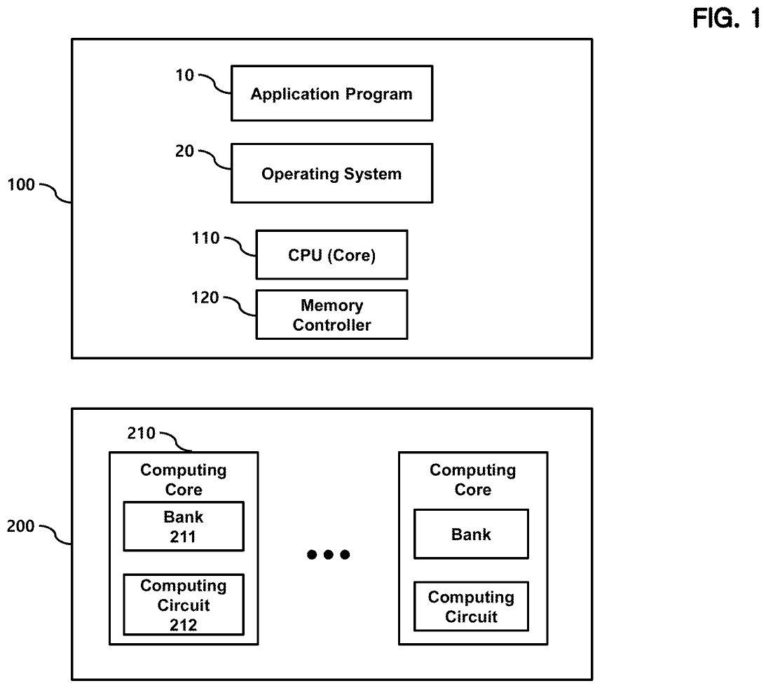

FIG. 1 is a block diagram illustrating a parallel processing system according to an embodiment of the present disclosure.

The parallel processing system includes a host 100 and a memory device 200.

The host 100 includes a central processing unit (CPU) 110 and a memory controller 120.

The CPU 110 may include one or more cores.

The memory controller 120 generates read and write commands according to read and write requests generated by the CPU 110 and provides the read and write commands to the memory device 200.

In embodiments, the CPU 110 generates a processing-in-memory (PIM) request, and the memory controller 120 generates a PIM command in response to the PIM request and provides the PIM command to the memory device 200.

A PIM request or a PIM command is a request or a command that supports corresponding in-memory processing.

The memory device 200 includes a plurality of banks 211 and a plurality of computing circuits 212 allocated to the plurality of banks to perform in-memory processing.

In the illustrated embodiment, one bank 211 and one computing circuit 212 may form a computing core 210.

For a bank 211 of the memory device 200, general read and write commands may be processed as in the prior art.

The in-memory processing includes performing an operation of the computing circuit 212 using data read from the bank 211, and storing data output from the computing circuit 212 into the bank 211.

Embodiments relate to performing in-memory processing by associating a thread created in the host 100 with a computing core.

Specific configurations and operations of the host 100 and the memory device 200 that generate and process a PIM command for in-memory processing are outside the scope of the present invention.

For example, a technique for generating a PIM command in the memory controller 120 in the format of a general DRAM command and a technique for performing in-memory processing by interpreting the PIM command in the memory device 200 are disclosed in detail in Korean Patent Application No. 10-2019-0054844 and Korean Patent Application No. 10-2020-0152938, for which the inventors thereof are the inventors of the present application.

The above two applications are examples regarding specific configurations of a host and a memory device for in-memory processing, but the present invention is not established on the premise of these applications and embodiments of the present invention are not limited thereto.

The host 100 operates according to software including an application program 10 and an operating system 20.

In this embodiment, the application program 10 includes program code requiring in-memory processing.

During operations of the software, multiple threads can be created to process a given operation.

In the illustrated embodiment, the host 100 operates based on a shared memory model using the entire memory device 200 as one address space as in a conventional computer system.

Conventional application programs perform parallel processing operations through shared memory-based parallel program APIs such as the Portable Operating System Interface (POSIX) Thread (Pthreads) API or the OpenMP API.

In embodiments, a parallel processing operation can be performed by creating a plurality of threads and respectively allocating them to a plurality of computing cores.

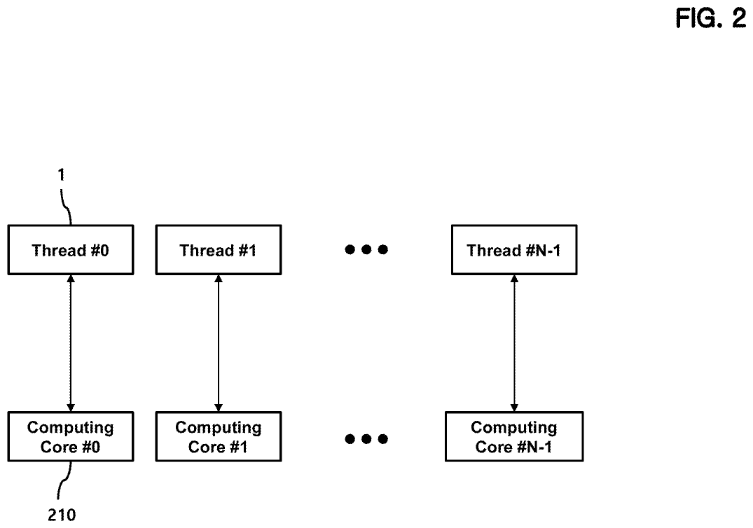

FIG. 2 is a block diagram illustrating relationships between threads and computing cores.

In FIG. 2, N threads 1 and N computing cores 210 are shown, where N is a natural number greater than 1. The threads and the computing cores are related in a 1:1 manner.

For example, the 0th thread 1 may be allocated to the 0th computing core 210, and the remaining threads may be respectively allocated to the remaining computing cores.

Subsequently, a PIM command generated in the 0th thread 1 is transmitted to the 0th computing core 210 for processing, a PIM command generated in the 1st thread 1 is transmitted to the 1st computing core 210 for processing, and so on.

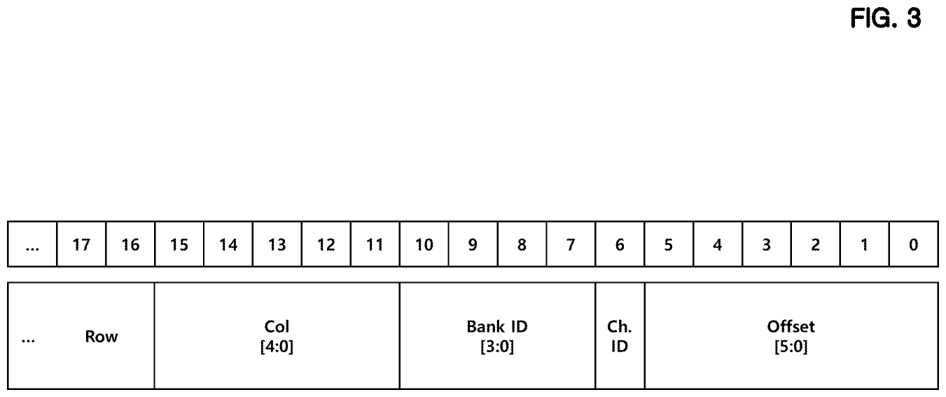

FIG. 3 is a block diagram illustrating indicating computing cores using an address.

In this embodiment, an address includes 6 offset bits, one channel bit, 4 bank bits, 5 column address bits, and a plurality of row address bits.

In this embodiment, one bank and one computing circuit are combined to form each computing core.

Accordingly, a total of 32 computing cores can be identified using a combination of the four bank bits and the one channel bit.

For example, data used by the host may be stored in a bank corresponding to an address of the form shown in FIG. 3. Accordingly, a PIM command provided by the 0th thread can be associated with 0th channel and 0th bank according to the address.

As described above, in embodiments, a plurality of computing cores operate as a distributed memory in which a separate address is allocated to each computing core.

Returning to FIG. 1, in this embodiment, one computing circuit 212 is coupled to one bank 211 to form a computing core 210.

As a result, data cannot be physically exchanged directly between different computing cores 210.

Accordingly, in embodiments, data can be exchanged between the computing cores 210 by the host 100 performing a memory copy operation.

The memory copy operation may be executed through a program code included in an application program 10 of the host 100.

For example, a memory copy operation between the 0th bank and the 1st bank may be performed by sequentially performing a read operation for reading data in the 0th bank and a write operation for writing data in the 1st bank.

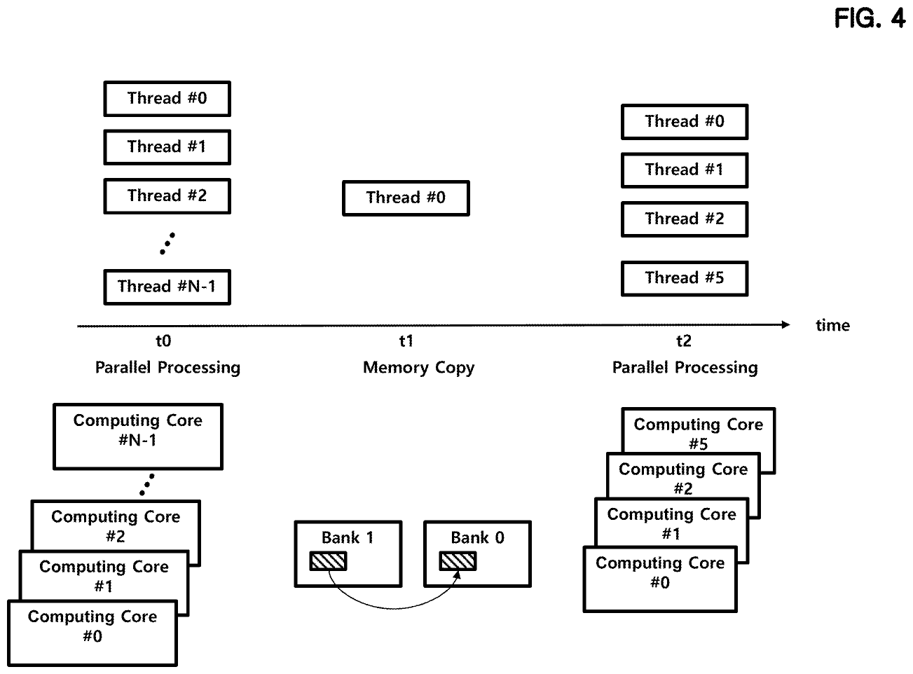

FIG. 4 illustrates a flow of in-memory processing according to an embodiment of the present disclosure.

At times t0 and t2, a plurality of computing cores perform in-memory processing in parallel under the respective control of a plurality of corresponding threads.

At time t1, if the 0th thread needs data of the 1st thread, software in the host 100 can cause a memory copy operation from the 1st bank 1 to the 0th bank to be performed.

In this manner, in a host using a shared memory model, shared memory-based parallel program APIs such as OpenMP and Pthread can be adapted to use computing cores operating as a distributed memory.

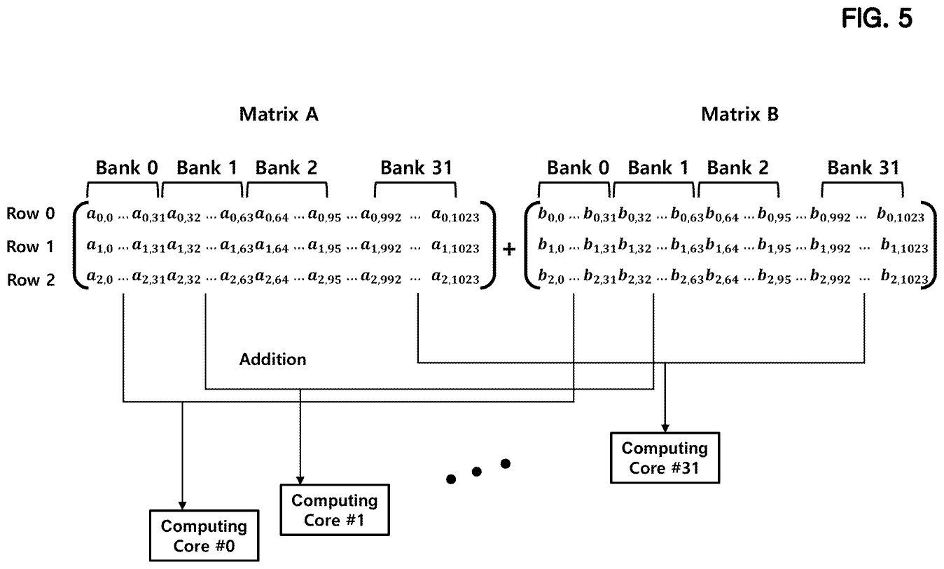

FIG. 5 is a diagram illustrating in-memory processing according to an embodiment of the present disclosure.

The embodiment of FIG. 5 shows an operation of processing an operation for adding two matrices A and B in parallel.

Each matrix has 3 rows and 1024 columns. In the illustrated embodiment, different groups of columns of each matrix are stored in different banks, where each group includes elements that are in 32 consecutive columns.

In the example address format of FIG. 3, 64 bytes of data are identified for each combination of a bank address and a channel address according to a 6-bit offset address Offset[5:0].

Accordingly, when 32 elements from each row are stored in each bank as shown in FIG. 5, each element may be a 2-byte data. If each element is a 4-byte data, 16 elements from each row may be stored in each bank.

That is, columns 0 to 31 of the matrix A and matrix B are stored in the 0th bank, and columns 992 to 1023 are stored in the 31st bank.

For a matrix addition, the addition may be performed in parallel in the 32 computing cores respectively corresponding to the 32 banks.

For example, the elements of Matrix A stored in the 0th bank are added to the elements of Matrix B stored in the 0th bank by the 0th computing core, and the elements of Matrix A stored in the 31st bank are added to the elements of Matrix B stored in the 31st bank by the 31st computing core.

Results of additions may be stored in corresponding banks to construct a new matrix.

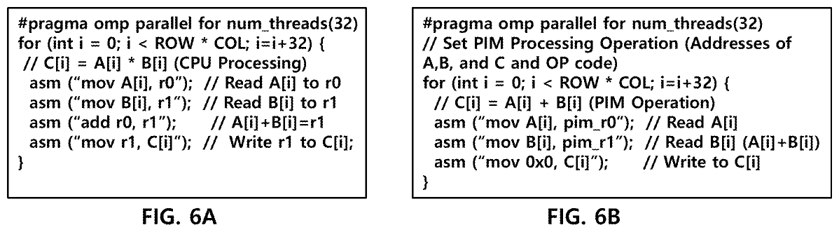

FIGS. 6A and 6B shows program codes for performing the matrix addition of FIG. 5. While matrix addition is provided as an illustrative example, embodiments are not limited thereto, and in embodiments, other vector and matrix operations may also be performed.

FIG. 6A is an example of a program code for performing matrix addition in parallel for a conventional CPU, and FIG. 6B is an example of a program code for performing matrix addition through in-memory processing using a memory device having a computing circuit.

In FIGS. 6A and 6B, “#pragma omp parallel for num_threads(32)” is a declaration indicating that 32 threads will be created in parallel using OpenMP APIs.

In FIG. 6A, elements of the matrix A are stored in the first register r0, elements of the matrix B are stored in the second register r1, the value of the second register r1 are updated with the result of adding the first register r0 to the second register r1, and then the value of the second register r1 is stored as an element of the matrix C.

In FIG. 6A, the first register r0 and the second register r1 are registers included in the CPU, that is, the host.

As a result of an operation of the OpenMP API, 32 threads are created for 32 consecutive addresses for each index i, so the index i increases by 32.

The program code in FIG. 6B may be written by minimally changing the program code in FIG. 6A. That is, in embodiments, the conventional code utilizing OpenMP can be reused almost as it is.

As shown in FIG. 6B, the code is written in the form of reading the elements of the matrix A, reading the elements of the matrix B, and storing result of the addition of the elements of the matrices A and B in the matrix C.

A technique for processing a PIM command having the same format as a normal memory command is disclosed in the aforementioned Korean Patent Application No. 10-2019-0054844.

For example, the memory device may distinguish a general memory read command from a PIM read command by using an op code for the read command.

Also, the memory device may distinguish a general memory write command from a PIM write command by using an op code for the write command.

Techniques for interpreting various command codes using the OP codes are well known to those skilled in the art, and thus a detailed description of the methods using the OP codes will be omitted.

As described above, a structure and an operation method of the memory device processing a PIM command having the same format as the general memory command is outside the scope of the present invention.

Returning to FIG. 6B, the host provides two read commands and one write command to the memory device.

In this case, the memory device may interpret the read commands and the write command as PIM read commands and a PIM write command instead of as general read commands and a general write command.

To this end, the memory device may be preset so that commands for addresses of matrices A, B, and C are interpreted as PIM commands.

For example, in order to process a PIM read command, an operation of storing data of the bank in a register inside a computing circuit of the corresponding computing core or accumulating data of the bank into a register included in the computing circuit may be performed.

For example, in order to process a PIM write command, data stored in a register included in a computing circuit of the computing core may be stored into a corresponding bank.

Processing a PIM read command or a PM write command, which is outside the scope of the present invention, is disclosed in Korean Patent Application No. 10-2020-0152938 of which the inventor of the present invention is also an inventor, so a detailed description thereof will be omitted.

In response to a first read command “mov A[i], pim_r0” issued from a thread, the memory device reads data of the matrix A stored in a bank of a computing core corresponding to the thread and stores the read data in the register pim_r0 of a computing circuit of the computing core.

In response to a second read command “mov B[i], pim_r1” issued from the thread, the memory device reads data of the matrix B stored in the bank, adds the read data to the data stored in the register pim_r0 of the computing circuit, and stores a result of the addition in the register pim_r1 of the computing circuit.

In response to a write command “mov 0×0, C[i]” issued from the thread, the memory device stores the data stored in the register pim_r1 of the computing circuit in a location corresponding to the matrix C in the bank. In this case, 0×0 of the write command corresponds to data to be written, but it can be ignored for the PIM write command.

When the above operations are processed, 32 threads are created for 32 consecutive addresses as a result of the operation of the OpenMP API. At this time, 32 threads are related to 32 computing cores in a 1:1 manner.

As described above, in embodiments, various parallel program codes can be written by allocating banks of a memory device connected to a host as independent computing cores to perform in-memory processing.

In addition, it is possible to easily reuse various program codes developed with conventional APIs for in-memory processing such as provided by the present invention.

Although various embodiments have been illustrated and described, various changes and modifications may be made to the described embodiments without departing from the spirit and scope of the invention as defined by the following claims.

What is claimed is:

1. A parallel processing system comprising:
a host including:
a central processing unit configured to process a processing in-memory (PIM) request generated in a plurality of threads for in-memory processing, and
a memory controller configured to generate a PIM command corresponding to the PIM request; and
a memory device including a plurality of computing cores each including a bank and a computing circuit, the memory device configured to perform in-memory processing in one of the plurality of computing cores according to the PIM command,
wherein the host allocates the plurality of computing cores to the plurality of threads.

2. The parallel processing system according to claim 1, wherein each of the plurality of threads is allocated a computing core among the plurality of computing cores according to a bank address and generates a PIM request for a computing core allocated thereto.

3. The parallel processing system according to claim 1, wherein each of the plurality of threads is allocated a computing core among the plurality of computing cores according to a bank address and a channel address and generates a PIM request for a computing core allocated thereto.

4. The parallel processing system according to claim 1, wherein the host performs a memory copy operation to copy data between a first computing core and a second computing core among the plurality of computing cores.

5. The parallel processing system according to claim 4, wherein the host controls an operation for storing data read from a bank included in the first computing core in the host, and an operation for writing data stored in the host into a bank included in the second computing core.

6. The parallel processing system according to claim 1, wherein the host controls a matrix operation with a first matrix and a second matrix,
wherein elements of the first matrix and the second matrix are stored in different banks of the memory device,
wherein corresponding elements of the first matrix and the second matrix are stored in a same bank of the memory device, and
wherein the host controls the plurality of computing cores to perform in-memory processing in parallel so that operations using corresponding elements of the first matrix and the second matrix are performed in parallel.

7. The parallel processing system according to claim 6, wherein groups of elements of the first matrix and the second matrix are stored in different banks of the memory device, wherein a group corresponds to a predetermined number of consecutive elements.

8. The parallel processing system according to claim 1, wherein the PIM command includes a PIM read command and a PIM write command, wherein the PIM read command has a same format as a memory read command, and the PIM write command has a same format as a memory write command.

9. The parallel processing system according to claim 8, wherein the memory device stores first data of a bank into a first register of a computing circuit corresponding to the bank according to a first PIM read command, performs an operation on data stored in the first register using second data of the bank according to a second PIM read command, and stores a result of the operation into a second register.

10. The parallel processing system according to claim 9, wherein the memory device stores data in the second register into the bank according to a PIM write command.
